(19) United States
(12) Patent Application Publication
(10) Pub. No.: US 2009/0070238 A1
(43) Pub. Date: Mar. 12, 2009

(54) DATABASE SYSTEM AND METHOD FOR TRACKING GOODS

(76) Inventor: William Moryto, Holmdel, NJ (US)

Correspondence Address: MILDE & HOFFBERG, LLP, 10 BANK STREET, SUITE 460, WHITE PLAINS, NY, 10606, US

(21) Appl. No.: 12/209,546

(22) Filed: Sep. 12, 2008

Related U.S. Application Data
(60) Provisional application No. 60/971,782, filed on Sep. 12, 2007.

(51) Int. Cl. G06Q 30/00; G06Q 10/00; G06Q 40/00; G06Q 99/00

(52) U.S. Cl. 705/28; 705/1; 705/37

(57) ABSTRACT

An online database method, comprising marking a plurality of gemstones with respective identifiers; maintaining a database linking the identifiers with at least a portion of at least one of a transaction history and a subjective description of the plurality of gemstones; updating the database with an economic value based on transactions involving respective gemstones; determining normalization parameters for extracting objective parameters determinative of value for each of a plurality of gemstones from the respective subjective description of the gemstones; and predicting a market value for a respective gemstone based on the subjective description of the respective gemstone, the normalization parameters, and the transaction history of a plurality of gemstones.

### FIELD OF THE INVENTION

The present invention relates to systems and methods for coding and tracking items, and databases for use in conjunction therewith.

### BACKGROUND OF THE INVENTION

Databases are well known for tracking items. Goods may be coded by serial number, product description (stock keeping unit or SKU), manufacturer or supplier, or the like. One example is the vehicle identification number (VIN) database, which stores VINs for essentially all vehicles, and which permit identification of manufacturer, year, options, and identity. This database has been linked to service history, ownership and registration, etc. Other databases are populated with Universal Product Numbers (UPN). Databases may be of a structured or unstructured type.

Databases have been proposed for gemstones, in which a unique code is microinscribed on the surface of a stone, which is then used for identification and authentication. See, U.S. Pat. Nos. 7,265,316, 7,010,938, 6,684,663, 6,476,351, 6,211,484, and 5,932,119.

### SUMMARY AND OBJECTS OF THE INVENTION

The present invention provides systems and methods for tracking goods which are generally not fungible, either because they have sentimental value for a particular item, or because of particular variations or intrinsic properties of an item.

According to a first embodiment, a database is provided for tracking particular items, which for example may have unique serial numbers, or other identifying indicia, or which otherwise are considered unique. This database may be used for item tracking and history, and also for linking information to the item which is not intrinsically associated with it. For example, a guest favor from a wedding may have an identifier which is indexed in a database, permitting the guest to later retrieve a wedding album or personalized wedding album from the database or an associated on-line service. This builds on the sentimental value of the “keepsake” and exploits modern data processing and internetworking capabilities.

According to a second embodiment, a gemstone bears an identifier, such as a serial number or bar code, which, for example, can be further authenticated by reference to irreproducible or difficult to reproduce characteristics of the gemstone. For example, natural gemstones typically have unique characteristics which are considered irreproducible. Likewise, a precise facet cut pattern of a gemstone may be very difficult to reproduce. Therefore, the gemstone may form part of a token, for example a ring, which can be authenticated or self-authenticated. Further, an information record may be provided with the authentication token, to link the authentication of the token to another item or object. Again, this information record may be physically associated with the authentication token, permitting self-authentication, or logically associated but remotely stored, permitting “on-line” authentication. In either case, the authentication token may be used to authenticate an item or object, such as the wearer of the ring. For example, the information record may be a biometric record. However, the item or object need not be a person. In particular, if the gemstone is relatively valuable, it can generally be used to authenticate objects or items of less than or equal valuable to it (including costs of counterfeiting the authentication information), though this relative value is not a particular limitation on the method or token. In any case, the conveyance of the authentication token in the form of jewelry or the like is fashionable and convenient.

According to a third embodiment, a unique item can be commoditized by understanding the elements which contribute to its market value, and determining or predicting a market value for the unique item from transactions of related items. While the idea of “comparables” is known in the valuation arts, this technique is complicated in cases where the identification and recording of a characterization of the unique item is subjective. In that case, further analysis may be required to compensate for biases or perturbations of the characterization (e.g., grading) reports. For example, diamonds are typically graded based on weight, color, clarity, cut, and other factors. However, variations occur within a particular grading facility, and between grading facilities. A certification laboratory typically does not assign a valuation with its report. Meanwhile, “appraisals” are typically considered unreliable. While there are published reports indicating gemstone valuation, these reports do not define a market value for a particular gemstone, which is subject to negotiation based on particular characteristics of the gemstone, as well as immediate market conditions or bargaining positions of the parties.

By providing a market value method, the basis of which can be agreed-to in advance by parties to a transaction, it become possible to engage in commodities future type transactions with respect to unique and non-commodity items belonging to a common class, while permitting commerce and trading in the items. Since the commercial usage is not preempted by the transfer of future risk, the current carrying cost can be separate from the pricing fluctuation risk, thereby permitting investment in and assumption of that risk on one hand, and transfer and hedging of that risk on the other. These derivative transactions generally increase liquidity in a market, and can make the market overall more efficient.

It is therefore an object to provide a method for trading a natural gemstone, comprising obtaining a grading of a gemstone to define a set of intrinsic characteristics upon which economic value of the gemstone is based, obtaining a grading of a substitute gemstone to define a respective set of intrinsic characteristics upon which economic value of the substitute gemstone is based, durably linking the gemstone and the substitute gemstone with respective reports of the grading, computing at least one normalization factor for comparing grading reports, maintaining a database of gemstone trading transactions which define a gemstone market price and a sensitivity of the market price to variations in price with respect to variations in the set of intrinsic characteristics, defining a future transaction between at least two parties for a transfer of the gemstone, with a right of substitution, and delivering, at the closing of the transaction, the substitute gemstone, and computing a difference in economic value between the gemstone and the substitute gemstone based on the respective sets of intrinsic characteristics, at least one normalization factor, and information extracted or derived from the database.

It is a further object to provide an automated trading method for gemstones, comprising receiving an identification of at least one gemstone, respective certification or grading reports for the at least one gemstone, and an identification of the certifier or grader preparing the certification or grading report, analyzing a recent history of market trades for similar gemstones, with reference to pricing and certification or grading reports, to determine a pricing bias, and transacting a transfer of the at least one gemstone, wherein a negotiation between buyer and seller is based on the respective certification or grading reports for the at least one gemstone, the history of recent trades, and the pricing bias. The method can further comprise maintaining a database of gemstone trading transactions which define a gemstone market price and a sensitivity of the market price with respect to variations in a set of intrinsic characteristics of the gemstone in a respective certification or grading report and an identification of the certifier or grader preparing the certification or grading report, and generating a predicted value of the gemstone based on the database, respective certification or grading report and an identification of the certifier or grader preparing the certification or grading report.

It is still another object to provide an online database method, comprising marking a plurality of gemstones with respective identifiers, maintaining a database linking the identifiers with at least a portion of at least one of a transaction history and a subjective description of the plurality of gemstones, updating the database with an economic value based on transactions involving respective gemstones, determining normalization parameters for extracting objective parameters determinative of value for each of a plurality of gemstones from the respective subjective description of the gemstones, and predicting a market value for a respective gemstone based on the subjective description of the respective gemstone, the normalization parameters, and the transaction history of a plurality of gemstones. The database may comprise**** data relating to gemstone trading transactions which define a gemstone market price and a sensitivity of the market price with respect to variations in a set of intrinsic characteristics of the gemstone in a respective certification or grading report and an identification of the certifier or grader preparing the certification or grading report, and wherein the normalization parameters are dependent on the database, respective certification or grading report and an identification of the certifier or grader preparing the certification or grading report.

Another object provides a method of establishing a forward market for a type of gemstones, comprising for each gemstone or set of gemstones, providing a database record defining a set of characteristics thereof, defining a database reporting transactions establishing a current market for the type of gemstones, each transaction comprising the transaction price and the set of characteristics, interpolating, from the reported transactions and historical trends, a predicted current market value for a gemstone or set of gemstones having a particular set of characteristics, entering a forward transaction for a gemstone or set of gemstones having the particular set of characteristics, with a right of substitution of gemstones having characteristics within a predefined range with an offset price in dependence on a difference between the gemstone and the respective substitute gemstone, having a set of deal parameters, closing the forward transaction for the gemstone or set of gemstones wherein at least one gemstone is substituted, and calculating an offset price to compensate for difference between the gemstone or set of gemstones and the gemstone or set of gemstones wherein at least one gemstone is substituted. The database record may further comprise an identification of a certifier or grader who defines the set of characteristics. The offset price may be dependent on the set of characteristics of the gemstone or set of gemstones wherein at least one gemstone is substituted, the interpolated predicted current market value, and the set of deal parameters. The offset price may also be established by a market transaction price for at least one substituted gemstone.

It is also an object to provide an authentication token, comprising a natural gemstone, having an associated data record to specify a set of irreproducible characteristics thereof to sufficient precision to achieve a reliability criterion, said gemstone being inscribed with at least one of an identifier for lookup in a database and a self-authentication marking, the database or self-authentication marking storing sufficient information to permit reliable authentication of the gemstone, said authentication token being logically associated with an item to be authenticated, and wherein a reliable authentication of said gemstone serves to reliable authenticate the item. The irreproducible characteristics may comprise a set of markings made on the gemstone. The irreproducible characteristics may comprise a set of natural imperfections of the gemstone and/or a cut configuration of the gemstone. The authentication token may be provided in conjunction with an automated reader for reading the data record and the set of irreproducible characteristics, and determining an authenticity of the gemstone.

It is a further object to provide a method of transferring a pricing volatility risk from a gemstone, comprising entering into a repurchase obligation agreement to sell and later repurchase or provide compensating value for at least one gemstone, and upon the repurchase date, delivering the at least one gemstone, at least one substitute gemstone and an offset payment, and a market price payment, wherein the purchaser/reseller undertakes a market valuation change risk between the sale date and the repurchase date, and the seller/repurchaser undertakes a carrying cost and maintains an ability to trade the at least one gemstone by maintaining a right to substitute or cover based on an agreed market valuation determination of the at least one gemstone and optionally the substitute gemstone effective on the repurchase date. The repurchase may occur at a predetermined time, a time selected by the purchaser, a time selected by the seller, a time determined by some external trigger event, or some hybrid thereof, for example. A seller may contract with a third party to cover on his behalf.

Another object provides a method, comprising the steps of determining a set of physical attributes of a gemstone, automatically determining a current market value relationship of the set of physical attributes from a database of reported gemstone transactions, determining a feasible alteration of the set of physical attributes and a market value for the altered gemstone, and modifying the set of physical attributes of the gemstone to the altered set to optimally increase its market value.

Still another object provides an online database system, comprising a database, adapted to store arbitrary digital objects, each record being retrievable by a database management system by at least one index, a user interface, for receiving an identifier from a user, presenting to the user a representation of at least one digital object, the index of the digital object being logically associated with the identifier, and receiving from the user at least one digital object for storage in the database wherein an index is assigned which is logically associated with the identifier, and a third party interface, permitting a third party to add data to the database, which is logically associated with the identifier in dependence on a content of the data, and without requiring knowledge by the third party of the identifier. At least one digital object may be stored in the database which is subject to a digital rights management restriction which requires compensation to a fourth party for use of the digital object, wherein the database management system accounts for use of the digital object and compensates the fourth party, and wherein the third party and the fourth party may be the same or different.

### BRIEF DESCRIPTION OF THE DRAWINGS

The preferred embodiments will now be explained by way of the drawings, in which:

FIG. 1A shows a prior art marked gemstone and FIG. 1B shows a detail thereof;

FIG. 2 shows a schematic diagram of a database system according to a first embodiment of the invention;

FIG. 3 shows an authentication token according to a second embodiment of the present invention, employing for example, the marked gemstone shown in FIGS. 1A and 1B;

FIG. 4 shows a flowchart according to a third embodiment of the present invention;

FIG. 5 shows a flowchart according to a fourth embodiment of the present invention;

FIG. 6 shows a flowchart according to a fifth embodiment of the present invention;

FIG. 7 shows a flowchart according to a sixth embodiment of the present invention;

FIG. 8 shows a flowchart according to a seventh embodiment of the present invention; and

FIG. 9 shows a flowchart according to a eighth embodiment of the present invention.

### DESCRIPTION OF THE INVENTION

One aspect of the invention provides an online searchable system, for determining ownership of goods, which may be populated by either or both of sellers and buyers, and which may be used to determine ownership and history, and also to provide support for transactions, insurance, warranty and recall, theft recovery, ownership authentication, off sight storage collection and organization and for other purposes.

By providing an electronic linkage which can, in one embodiment, support arbitrary information, the item may serve as an entry point to electronic content. This, in turn, may be used to record ancillary information of sentimental value relating to the item. For example, a diamond engagement ring stone may be inscribed with an identification number. That number, in turn, can provide an index to a remote or on-line (Internet) database which records, for example, images, sounds, video, or the like from the wedding. Indeed, third parties may link messages to the bride and groom to the database entry. Later, anniversary celebrations may also lead to additional uploads or linkages. Access to the database may be public or private, and known access control and authentication schemes may be implemented. In some cases, digital rights management and paid access may also be supported; for example, wedding music portrayed in the on-line “album” may be subject to restricted license, and therefore a royalty payment may be required to render such copyright content. For example, an option may be provided to filter such restricted content (either by truncation or substitution, for example) in the event that the royalties are not paid. Indeed, the owner of the content may have an implied license or fair use defense, and once authenticated, the owner may not be required to pay any such royalties, while third party use may require payment of royalties.

Because the database, in this case, is remotely managed, it can be maintained essentially in perpetuity. This then allows, for example, the authentication and preservation of the history and historical value of durable items.

Typically, the items to be registered in the database have unique identification numbers or codes, and thus the database entry tracks a specific good. In other cases, the identifying information is generic, for example a model number. Likewise, in some cases, privacy concerns warrant limiting the use of individually identifying information, and therefore the use of generic or non-unique identifiers, which provide useful information identifying the type of item, but not its owner or history.

One possible use for the system is to make counterfeiting more difficult. If goods are provided with unique identifiers which are then authenticatable, a purchaser can determine whether the identifier has previously been assigned, and perhaps who the current registrant is. Thus, a purchaser could readily tell if the identifier is duplicative, or the alleged owner differs from the registered owner. Even where privacy concerns limit publication of information regarding the owner or buyer, the availability of manufacturing and distribution information may be quite useful.

Without privacy protection technologies, this sort of database could result in negative consequences, for example serving as an invitation for theft of specific goods, or release of private information. Therefore, the database preferably supports access controls and limitations, such that in general, database queries do not substantially leak personal information unless this is authorized. For example, a database query might indicate only if a product identifier has been assigned by a manufacturer, and if so, whether there appears to be conflicting concurrent ownership information. However, this same query might be limited to prevent release of an identification of the owner.

A similar concept provides that a gemstone, perhaps one that deviates from “perfect” in a number of ways, is provided as a difficult to counterfeit identification token. A user, for example, can wear a piece of jewelry in which one or more stones is used as a basis of an authentication scheme. Typically, the stone or its mounting will bear a human-readable indicia of identification, such as a serial number, which will serve as a basis for authentication. In other cases, the features of the stone itself will be presumed unique, and the stone will be self-authenticating. Indeed, assuming that the authentication is considered an important purpose of the stone, during the registration process, stones may be intentionally modified, to ensure uniqueness. For example, an identifying inscription itself may serve as the modification; however, typical inscriptions are shallow and can be polished off the stone, while the identifying indicia may preferably be deeper and/or intrinsic. Therefore, it is preferred that at least one modification be such that removal of that modification would result in a change of other characterizing information, such as carat weight for a loose stone, or alteration of an inclusion or “flaw”.

Alternately, during the registration of the stone, the uniqueness may be assessed with respect to previously registered stones (or with respect to a standard representing a minimum number of features for authentication), and if the stone too closely matches another previously enrolled stone or has too few distinctive features, then it may be rejected, or modified in the registration process. This modification is typically one which is reasonably permanent, and readily ascertained. Since the scheme exploits markings on or imperfections in the stones, relatively lower quality gemstones can be preferred, though if the markings or imperfections are too dense, then authentication may be impeded and the authentication vector made too complex.

In order to facilitate standardization and automation, while exploiting the beauty and desirability, the selected stones may be of common types, for example round cut or emerald cut diamonds, having a size of 0.25-1.00 carat. In order to provide a suitable level of uniqueness, the various characteristics of the stones which are subject to variation may be encoded with sufficient accuracy to provide a reliable authentication. For example, inclusions in the stone (or clear regions) may be spatially encoded in three dimensions, for example, with a 10-25 micron precision. Because of their complexity, feather inclusions and fractures are not preferred as a basis for coding uniqueness. A two angle measurement, or vari-focal measurement, for example, may be used to code depth.

Preferably, an automated and/or computerized analysis of an image is provided, to differentiate reflections and the like from primary inclusions. Likewise, it may be desirable to analyze the inclusions under monochromatic light, to avoid chromatic dispersion effects.

Authentication of a stone preferably includes a measurement of refractive index, to verify the base material. Further, it may be desirable to generally identify at least one feather inclusion or fracture which is generally coded, since such flaws are more difficult to obtain or copy into in synthetic materials.

Consumer Database System

One embodiment of the present invention provides a consumer database of “possessions”, providing to consumers the benefit of a consolidated repository of consumer information, such as purchases, assets, etc. This same database provides substantial opportunities for targeted marketing and data mining, and thus subsidies for the database operations, and beneficial transactional opportunities. The resulting database may provide a dense data set from which behavioral and attitudinal statistics can be drawn and projections can be made.

Many prior proposals have sought to surreptitiously obtain consumer data, or encourage or incentivize consumers to cooperate with data collection processes. However, what is often missing is the demonstrated and significant value to the consumer. For example, often, the net benefit to a consumer of this type of personal information database is targeted advertising, and perhaps discount offers. The present system and method provide a useful database intended, at least in part, for intentional and direct consumer exploitation of the information.

The database may be populated by a manual process of data entry, either by keyboard entry, UPC (or similar) code scanning, credit card and transactional receipt recordation (or statement downloading), also vendor reported transactions, or other monitoring techniques. For example, a user may use a digital camera or cell-phone camera to acquire identifying images of a product, which can then be used to populate the database. For example, a UPC code and serial number (often also present as a bar code) can be acquired, and then the information used to query a remote database, such as the manufacturer database, to register the product with the buyer. This may also be used to facilitate rebate condition compliance and processing.

A particular product may therefore be tracked online via a serial number, or other identifying information that identifies a particular product, or by other means such as product description, manufacturer, date of production, ownership history, etc. Users may have information regarding a particular product such as product components, which can be supplied by the product manufacturers and can be extracted using an on-line query response system, which may optionally be configured to provide privacy protection; that is, an intermediary may be provided between a consumer and manufacturer or other third parties to avoid unnecessary or unintentional release of personal information. According to one embodiment, the full query of the user-specific data remains private, with strong authentication and safeguards against malicious or detrimental use. In one example, the user-specific database is maintained encrypted so that even the host system remains ignorant of its contents. However, preferably, an intelligent agent is available which (typically with user permission) exploits generic information to provide marketing, product safety or other types of information to the user and potentially to propose or assist in proposing transactions. These marketing, disclosure, and transactional elements may fund the system, and provide an alternate to recurring user fees, and indeed if properly tailored to the user, provide distinct benefits and efficiencies.

In order to balance privacy and useful exploitation of valuable information (and likely corresponding subsidies to support the system), a number of methods are available. With respect to limiting government use, or government ordered disclosure of this information, perhaps the only method available is secure encryption and no permitted third party use. In this case, the on-line repository serves as a “locker”, and the information is generally unavailable for useful exploitation except by or under authorization of the owner. However, it is possible to use one-way hash schemes (e.g., HAVAL, MD2, MD4, MD5, PANAMA, RadioGatun, RIPEMD, RIPEMD-128/256, RIPEMD-160/320, SHA-0, SHA-1, SHA-256/224, SHA-512/384, Tiger(2)-192/160/128, VEST-4/8 (hash mode), VEST-16/32 (hash mode), WHIRLPOOL) to authenticate verify the existence and of information without releasing the actual information. This, in turn, permits inferential searching and verification without express release of information. Indeed, by intentionally using a hash system which is subject to collision (identical hash codes), the forensic reliability of the system is reduced, and therefore privacy increased, perhaps without greatly diminishing the practical value of the system and with a likely reduction in cryptographic processing burden. A second level of use for the information is, for example, filtered use, in which the database operator serves as a proxy and filters the contents on behalf of third parties, such as advertisers, forwarding relevant or corresponding messages, without yielding the identity of the recipient to the third party.

A third level of use permits the user him or herself to sell or exploit the information, which can be sold or rented, in whole or in part, to third parties. For example, a demographer may seek dense information on individuals, and pay for that privilege.

A fourth level of use permits restricted or unrestricted public access. This level may provide some opportunities for revenue, e.g., banner ads, referral revenues, but typically has limited financial value to the owner attributable to the use. For example, a user happy or unhappy with a product may publish a blog including his or her experiences, tending to reward or punish the supplier as the case may be.

According to one embodiment, the user creates a profile on a website and discloses registration information, which may be, for example, name and address, photograph, voice sample, or other biographical or biometric indicia. Once the profile has been created on the website, it is possible to start utilizing the searchable system. The user can manually upload information onto his online account regarding his current possessions using information such as item identifications and serial numbers. The online account may consist of the user's possession ownership and disposal history, and current possessions as well as a search page. Optionally, the use may link various information which is either directly relevant, such as rebate processing information, warranty information, repair history, etc., or arbitrary. Such information can be invaluable in case of damage to the home that will incur losses, and since the storage is off-site, damage to the possessions is generally uncorrelated to damage to the stored information. Tracking the user's possessions on this system enables insurance companies to determine losses that the user has incurred in case of property damage and, among other things, can serve as a “virtual” safe deposit box for data and records of the user.

This system may retrieve other information from other sources, and thus the user may provide only limited information, yet benefit from automatic population of the database. The system may also use the information to retrieve, anonymously or openly, information from other users or reviewers for the products in the database. Thus, a user may be altered to likely prospective or actual problems, and possibly solutions. For instance, a manufacturer can give the database manager access to its database containing the serial numbers, product description, product components and other such valuable information. As a result, when the user enters the serial number of a certain product, the database will automatically search for the particular serial number throughout the manufacturers' databases, and input the product's detailed information next to the newly entered serial number on the user's account. This ensures that the user will not have to manually type in the product description and other pertinent information such as date of manufacture.

The system may also be used in cases of prospective purchases or acquisitions, seeking to understand issues which have arisen for others with the same products. Thus, for example, a user seeking to purchase a product can retrieve a service repair history for similar goods, to identify good and poor choices. For example, a Carfax-type database may be used to search for cars with good and bad repair or accident histories.

For purchased items, it is possible to update the system automatically at the store or credit card processor. For instance, if a user who has already established an account buys a television, it is possible to automatically upload his purchase directly into the database system. The actual transaction itself will be made at the physical checkout in a “bricks and mortar” retail store, or through the database system in an on-line transaction.

In a traditional retail transaction, the cashier may scan the product's bar code containing the product's serial code into the computer. If the payment is by credit card, once the credit card has been swiped, the user's name, billing address as well as the product serial code may be entered into the vendor's purchase records. If the vendor and database system operator have an agreement such as to allow all the vendor's purchase transactions (which may be recorded through warranty, rebate or affinity program registrations, for example) to be entered into the database system, the transaction may also be automatically associated with the consumer's account. Throughout the entire process, the user's privacy may be largely respected, since the data sources are largely those which inherently hold the information. As a result, by registering a data source (such as credit card processor) with the database system, it is unnecessary for the user to manually input new transactions; it has automatically been accomplished via the vendor. However, in the scenario where the user pays with cash instead of a credit card, automatic update may be possible if the user is content with divulging his user account or identity to the cashier. In the event that he wishes to remain anonymous, the user can later input the purchased product's serial code into the system or use a personal identification number to allow the merchant to provide automatic update of the data base.

The database may also be populated by shippers and carriers, since the shipper often knows the contents of a package, and the identity of the recipient is reported. Therefore, exploiting shipper databases may be efficient and impose low risk of additional privacy violations. This integration may be of benefit to the user, since it will allow the user to be able to track his packages from purchase until delivery to his door.

When the user searches through a public portal, the results may be integrated with, or biased by, his own private information database. Thus, the database need not be limited to possessions and goods, but may also encompass services used, and other user-specific information. Thus, instead of the vast repositories of private information held by various interests being purely a threat to user privacy, the present system provides diverse opportunities to exploit this information for the user's benefit.

An additional feature of this system provides a history of ownership. Each time a particular serial number is entered into a different account, the user or a reference will be added in the item's ownership history. Thus when a particular product has been traced via its serial number, it will be possible to find out the ownership history of the product. This may be used to track stolen goods, determine authenticity, and provenance. This, for example, may be beneficial to users of on-line used goods sites, such as Craig's list and eBay. Before purchasing a used (or in some cases, new) product on-line, if the item's serial number can be located, it will be possible to determine or assess the seller has good title to the item, and whether it is as described. Further, it may be possible to determine a service history and manufacturing lot/model issues, such as design defects. Of course, as discussed above, an owner typically will have to expressly waive the secrecy of the information, but where the seller makes an affirmative representation regarding prior ownership, this may not be a particular problem or impediment.

The system may will also periodically contact users to ensure that they still own the items they registered. This way, if an item is lost or stolen, the user might offer a reward for its return, and let potential finders and registrants know of the reward. Also, the system would be able to prevent the resale of stolen goods, if the new owner checks through the system that the seller's title is valid. At the same time, the system may should allow for discarded items to be resold by finders or allow an owner to otherwise disclaim or disavow a relationship with the item. Further, options may be provided to expunge the public record and/or private record of data, or to edit the record, preferably with an audit trail. In one embodiment, thus, if a user does not send a confirmation of ownership for a certain period of time, the system could treat the item as discarded (or given or sold to another party, etc.) such that another party may then claim title without triggering an exception. Also, users should be able to easily report to the system that they have chosen to discard old and unwanted items, thus clearing the title for potential future finders who wish to resell those items.

There might be a problem due to user negligence or indifference. For example, a person could negligently claim that he still owns a TV and MP3 player that he threw away or sold. Thus, the system may provide a forum for resolution or should allow for “title disputes.” If one party believes that it legally owns an item that the system claims belongs to another, the party should be able to enter a title dispute process may be initiated. Initiating a title dispute might involve paying a fee, or the costs may be borne by the system as a whole. The parties would provide a written or oral statement to the system, which would then determine which party's title was valid, and record the decision. An undertaking or other security may be provided in the event that the title remains disputed after a mediation and/or investigation. While a binding arbitration process may be employed in some cases where both parties agree, in other cases legal or judicial intervention may be appropriate.

In some cases, access to the records by legal authorities may be sanctioned or encouraged. In other cases, the database and other aspects of the system may be implemented to retain privacy to the full extent permitted by law. In the later case, various security and encryption techniques may be employed to preserve privacy and constitutional rights, while still fulfilling one or more objective of the invention.

The system provides various opportunities for targeted advertising, marketing and product or service delivery. The system, for example, may have high quality information regarding the most frequent products/services/brands that the user possesses/purchases. The database system is supported by various interested parties such as advertisers, who pay for presentation of their advertisements to users. By permitting an advertiser to define with specificity the particular desired targets (based, for example, on ownership inventory, purchasing history, or indeed, goods not currently possessed), and in turn, presenting advertisements to user by those advertisers who truly value their potential business, substantial potential efficiencies are gained, and perhaps, a net reduction in advertising density will result. For example, this targeted advertising will occur through all venues, not only based on use of the private information database. This data also permits projection of individual or group (cohort) trends and buying decisions, and the implementation of social filters (e.g., collaborative filters) to predict consumer activity.

A useful feature of the database system is the ability to remind users of important dates, warranty expirations, service contract deadlines, etc. Each product may come with rebate deadlines, warranty expirations or sales promotions. The system will therefore have a regular utility for the user, with benefits for keeping the database records accurate and complete. Indeed, the system may be integrated with rebate processors, warranty and service companies, etc., and thus permit automation of the process. Several advantages for the user include documentation of current possessions in case of future loss, faster information regarding current possessions such as product components, more relevant advertisements tailored to the user's preferences regarding certain brands or products, convenient reminders of warranty expirations or rebate deadlines, and detailed documentation of a product's ownership history.

This database system will not merely be beneficial to the user. Manufacturers and vendors are also recipients of economic and efficiency gains. This detailed database may be able to track, and provide a basis from which to predict, consumer buying patterns. It may be possible to see or anticipate the most popular brands for a certain product and thus the manufacturer/vendor will be able to determine product or marketing campaign weaknesses and strengths. It may also be easier to predict or determine the demand for a certain product. Plus, the targeted advertising system will ensure that a greater proportion of advertisements will be focused on the appropriate market/demographic, thus leading to greater return on marketing investment.

### Micro Marked Gemstone, Related Systems, Applications & Business Models

A micro mark as referred to herein encompasses a marking that it is not normally visible to the unaided human eye. The marking may be formed by inscribing, etching, burning/branding, supplementing, engraving, relieving, or otherwise differentiating or marking a surface portion or sub-surface portion of a material, which may be, for example, a gemstone. The marking may be in the form of a bar code, data matrix code, or other identifying attribute. Such micro marking may further be a numeric, alphanumeric or other discernable symbol. In addition, the micro mark may take the form of a positive or negative electrical charge affecting at least a portion of a gemstone. Additionally, the micro mark may be accomplished by causing changes in the crystalline, chemical or atomic structure present in at least a portion of a gemstone.

One aspect of the invention provides a micro marked “reference number” for a gemstone according to a SKU-type logic, or cryptographic algorithmic code, thereby making the gemstone traceable and the reference number verifiable, and storing the reference number in a searchable database. The reference number may be constructed so as to provide a verifiable trail between the gemstone and its earlier points of ownership and/or manufacture or source of origin thereby, among other things, helping to prevent or detect illegal activities (including but not limited to the financing of terrorism, money laundering and trading in conflict diamonds) and assist in tracking/accounting, verification, loss prevention and recovery of gemstones. This micro marking may also facilitate reduction in insurance fraud and insurance costs, and facilitate transparency in pricing, financing and ownership of gemstones. The reference number and/or the database can be made secure through the use of encryption and/or a user supplied password.

The algorithmic code may be a function of, for example, a type of stone, company that manufactured or cut the stone, country or place of origin, Kimberly Process Number and/or other unique stone identifying number. The micro marking can be used to retrieve or centralize data that may be desirable to assist in information retrieval or centralization of administration in connection with the gemstone or reference number.

One or more elements of data that may be desirable to retrieve or centralize in connection with the micro marked gemstone or reference number may include the following: voice; computer data files, such as documents (e.g., PDF) and other electronic files and/or images, video clips or pictures, copies of invoices and/or insurance information, appraisals, genealogy information, an image or representation of the jewelry piece containing the micro marked gemstone, warranty or other product information, a reference number, information describing one or more of the attributes of the micro marked gemstone (e.g., cut, color, clarity, weight, location of one or more imperfections within or on the surface of the gemstone, an image or representation of a laboratory certification report or report number, a visual image or representation of all or part of the micro marked gemstone, a visual image or representation of all or part of the reference number).

In one embodiment of the invention the micro marked gemstone is automatically scanned (or the reference number is manually entered) into a computer or other automated system connected to the Internet or an intranet or other network. The reference number and/or related SKU-type logic facilitates the look up of one or more electronic records or files. The data on the stone may be structured or unstructured; that is, the information may be merely a reference number to an external record, or itself convey useful information, such as self-authentication and basic characterization information.

To illustrate, for example, a daughter inherits her mother's engagement ring. She scans in the reference number and views an image of her father proposing to her mother. She can view and hear her parents exchange vows on their wedding day. She can tell her daughter the particular stone is a diamond that was sourced in Botswana and cut by Lazare Kaplan International. Thus, the “sentimental” value of the ring is enhanced by storing for archival preservation associated information, which may increase the perceived value of the ring itself, and provide a possible revenue source for the holder of the archive.

Possible uses for the database system include:

Assigning reference numbers (potentially to both micro marked and unmarked gemstones);

Managing a database linked to or referenced by a micro marked reference number;

Storing data associated with the reference number;

Advertising or selling advertising in connection with the reference number or related micro marked gemstone or related data;

Enabling cost effective compliance with legal disclosures through the dissemination of product safety, warranty or similar information of an interested party (including but not limited to insurance, banking or other regulatory disclosures);

Data mining and/or the sale of information stored in or derived from information at least part of which was or is stored in the data base.

Industrial and Distribution Database

In many markets, the products, though falling within an established classification, have unique features, and thus are not typical fungible commodities. If the product has a unique feature, an aspect of that uniqueness might be provided, to permit verification of identification. See, U.S. Pat. No. 5,974,150, expressly incorporated herein by reference.

An example of a product class in which each product (above a commodity grade level) has unique characteristics is gemstones. As is known, gemstones may be microinscribed or micro marked with an identification, such as a serial number, bar code, 2D-data matrix code, or the like. See, U.S. Pat. Nos. 7,265,316, 7,010,938; 6,684,663; 6,476,351; 6,211,484; 5,932,119 and 4,392,476, expressly incorporated herein by reference.

Advantageously, the markings are counterfeit resistant, either due to an intrinsic aspect of the marking making it difficult to duplicate, or based on a characteristic of the goods which may be encoded in a self-authenticating code or in a remote database. For example, in the case of a cut diamond, information about the cut and/or natural variations (e.g., flaws) may be encoded, making it difficult to substitute or reproduce.

A typical database record for a gemstone would include, for example, some or all of the information from a laboratory grading report, ownership and optionally ownership history, identifying information (e.g., the code), and perhaps other authentication information which may be obscure, such as a particular refraction pattern which results from the interaction of facets and internal reflection, or characteristics of the girdle, or the like.

When a registered user, typically the owner, seeks to access the database, most or all of the information may be made available for retrieval. Some information is “owned” by the user, and may be changed or deleted. However, various information may be non-editable, such as the grading report, identifying or authentication information, etc. On the other hand, a non-registered user (e.g., non-owner) may have limited access to information, such as existence of a serial number, and perhaps a subset of the authentication information, and is generally limited in editing capability, for records. The registered user may, for example, be able to prove ownership, by demonstrating access to the database record which may include other authentication information.

Many gemstones (including diamonds) are highly durable and resistant to damage. Such gemstones, once micro marked, could serve as a lasting reference to data. The micro marked gemstone therefore may bear a machine-readable marking, that is, for example linked to customer financial data (such data may include banking or other information sufficient to allow a user to obtain or pay money or obtain credit by scanning or otherwise entering or referencing the micro mark). The gemstone may therefore serve as an authentication token, which is very difficult to replicate or forge, and therefore the determined authenticity of the token may be used to support substantial financial transactions. Therefore, the gemstone may be used to “carry” an economic value, which is typically administered through a remote database, though a self-authentication scheme may be used to carry the value on the gemstone itself. In the case of a self-authenticating scheme, a modification of the micro marking on the gemstone may be used to represent a consumption of the value represented in the marking.

Another aspect of the invention employs the authentication capability of the gemstone to further authenticate a person associated with the gemstone; that is, an article of jewelry which contains a gemstone, optionally a diamond, which has a complex and potentially unique “fingerprint”. This fingerprint can be used instead of human fingerprints, DNA, retinal scans or the like to identify the person, assuming that the person maintains control of the jewelry (or at least the gemstone). By combining a password and a stone's fingerprint verification or identification (i.e., two or more factor authentication), a person does not have to provide a physical cross-reference to authenticate himself. This would be important, for example, where a person wants to pass along an asset or right anonymously. A host may wish to limit the number of authorized guests/users, but may wish to leave responsibility for guest/user designation to a third party.

A further embodiment of this invention draws on the uniqueness of individual gemstones. For example, it is known that image analysis, spectral analysis and photo luminescence of diamonds can reveal complex and potentially unique identifying readings that differentiate individual diamonds. Diamonds are commonly differentiated from one another by visual inspection under magnification (considering factors including: color, florescence, clarity, cut, size, shape, the nature and placement of imperfections and irregularities) and by reference to mechanical measurements. In addition, diamonds can exhibit different electrical, atomic, crystalline, reflective and refractive properties. As such, a further embodiment uses a diamond or other gemstone, singularly or in combination with one or more additional diamonds or other gemstones and/or other secure codes or devices, as a product to be used to create a unique identifier or “fingerprint”.

The database may also have application for manufacturers, distributors, and merchants. Returning to the example of gemstones, typically, gemstones must be carefully examined in conjunction with each transfer. Thus, a merchant incurs a significant burden when acquiring, trading, or selling gemstones, as each stone must be examined by a trained person such as a gemologist at each juncture. While many gemstones are currently micro marked with an identification, reading the identification requires a skilled person to locate and read the inscription, and in some instances verify that the stone corresponds to the certificate which purports to describe it, since the string represented by an alphanumeric code can be readily duplicated. In contrast, an embodiment of the present system exploits machine-readable codes (which can be automatically observed and the stone authenticated) without requiring gemological skills on the part of the user. For example, a microphotograph of the girdle of the stone, on which the inscription is formed, is captured, and indeed using digital cameras, there is little impediment to capturing images of, for example, the entire girdle of the stone in the event that the location of the inscription is not readily apparent. At the same time, the camera can capture other information about the stone, for example details of the cut or natural variations that are difficult or nearly impossible to duplicate with another stone. A remote database may be therefore provided, which can then authenticate the stone based on the machine readable code and potentially the machine readable authentication information. The stone may also have a self-authenticating message on it. To abate the risk that the cryptographic code which underlies the self-authentication might be compromised, amplified by the fact that the stones are durable, and thus must maintain their value into the future, a plurality of different type codes may be provided, including a remote authentication scheme operating in parallel with the self-authentication.

Market Transparency Exchange Database

In addition to the information discussed above, the database (or a related data record) may store a transaction price or other economic information, which may be used to establish liquid and/or efficient markets for the items, even if their characteristics vary widely. That is, even if there are many degrees of freedom in each item, by storing accurate economic information for a broad range of transactions, it becomes possible to document market transactions, and thereby reduce the mispricing risk in transactions. This, in turn, increases liquidity in the markets, and facilitates organized derivative markets.

For example, if a significant portion of the wholesale market transactions in one or more type of gemstones is reported in a database, the market pricing for any future transaction involving such gemstones is more assured, and therefore pricing volatility is based on the market forces, and not inefficiencies in the market. Therefore, an investor seeking to invest in, or collateralize an investment with these assets, can be assured of lower transactional expenses, and therefore efficiently trade at slimmer margins, and in the event of collateralized transactions, with higher debt to collateral ratios.

This increased access to financial data lowers the cost of capital to manufacturers, distributors, and merchants, and makes their sales transactions more efficient and less prone to human error and illiquidity of inventory. While this same liquidity may erode an advantage of certain sellers or buyers who have traditionally exploited this inefficiency for gain (arbitrage), even for these participants there will be advantages.

Insurers will also gain, since appraisals will be more accurate, and loss payments more readily calculated. Consumers will likewise gain by the likely pass-on of some of the cost savings, and more accurate insurance coverage. Since the items are durably marked, the secondary market for illicit or stolen merchandise will be eroded, and therefore the incentives for theft or illicit trade reduced, leading to a possible further reduction in insurable risk. On the other hand, purchasers will have greater assurance of the pedigree of product acquired, and thus reduced risk in that regard as well.

Because the liquidity of the markets are improved, and therefore transactional expenses reduced as a percentage of the selling price, it becomes more feasible for financial interests to invest in market volatility risk, and for those with inventory to offload or hedge that risk.

The database and market pricing information need not be limited to only common or benchmark items, but may encompass a broad range of available inventory. For example, if the liquid market is limited to a subset of otherwise similar goods, this will itself create inefficiencies and arbitrage opportunities, leading to pricing anomalies and ultimately, may increase pricing volatility independent of the underlying natural market forces of the broader market. Further, limiting the creation of liquid markets to a subset of the trade will result in barriers, and possible hoarding and supply disruptions. While models may be employed to extrapolate pricing for non-standard items based on a similar standard items, these models have their limits, since the estimates may be inaccurate, and in any case, if not accurately based on actual market conditions, create inefficiencies, since the stated “market” price may be rejected by buyers and sellers as a sound basis for transactions.

While the gemstone or diamond trade is but a single example of the power of a rich database which exposes market pricing for possibly sporadic trades in ad hoc markets, the advantages are generic. For example, on-line auctions such as eBay present examples ad hoc marketplaces, in which market information is scarce, inter-item variability is substantial, and pricing variability high.

While there are rudimentary tools available for manually searching pricing and availability history for certain items, this picture is incomplete, unreliable, and potentially does not represent an efficient market price due to (what some market participants deem) high market fees, high broker fees, often high transportation fees, and other substantial inefficiencies and artifacts.

The present invention, however, preferably provides standardized and relatively complete information regarding items, authentication information, highly efficient transactions, and sufficient benefits for accurate reporting of such trades that self-policing would limit aberrations. While retail consumers (i.e., individual customers of retail stores) might participate in the same database system, these transactions are associated with higher transaction costs, and therefore are less reliable as price indicators of efficient markets. On the other hand, retail sales are typically priced by individual items, and therefore the issues involving bulk transactions are less evident.

In a wholesale trade, often a transaction involves multiple units. The price may be negotiated on the entire transaction, and not on individual items within the trade. However, by providing accurate reporting of the constituents of a bulk transaction, and analyzing these in conjunction with other individual transactions, an analysis may be performed to reveal hidden pricing presumptions.

Another use for this database is to help find potential buyers or sellers of items. For example, if a jeweler seeks to acquire particular inventory (at a market price or a limit price), it may contact directly, or through a transaction broker (who will then anonymously contact) the owner or various owners of inventory sought to be acquired. This can be conducted electronically and automatically. After a potential buyer and seller are paired, the transaction may be negotiated and concluded openly, or anonymously through the broker. By permitting potential buyers and sellers to propose transactions through the market, instead of simply reporting past transactions, the database may be populated with bids and asks, as well as information relating to pricing density (i.e., the number of buyer and sellers seeking to transact). The opportunity for anonymity reduces the risk of exposing trading strategies. Likewise, the matched trade price may be automatically reported in the database. Assuming that the broker incurs no substantial risk in intermediating the trade, the costs for the intermediary service may be relatively low, and thus the market may remain efficient.

As is well known, there is an intrinsic link between market transparency, liquidity and efficiency. Hedging, speculative trading and thus open interest tend to increase in response to increased market volatility. Transparency enables traders to observe prices continuously, and thus immediately trade in response to changes in price. Liquidity may be sensitive to the market price. In a liquid market, there are only small price changes in response to orders. Fundamental demand for, and supply of, a commodity generates natural trading demands, while speculative trading provides liquidity and smoother prices. Thus, in a commodity market, where exploiting volatility is not the main avenue for profit for a substantial number of market participants (typically suppliers and end users), the increased liquidity of inventory and product typically improves business operations. More speculators or “noise” traders lead to a more liquid market. Speculators absorb information shocks and an increase in speculation means that an information shock is distributed among more “noise” traders, mitigating any excessive price disturbance. A trader with a demand for an immediate trade in an illiquid market causes price to move significantly, though temporarily (e.g. an order to buy a significant quantity of a stock may cause the price to move). All else being constant, a more liquid market would see smaller price jumps for the same order.

Transparency is the ability of market participants to view information associated with market orders and transactions. Traders naturally benefit from seeing other traders' information, conversely, traders would naturally prefer that others not be aware of their own information; this involves a “free rider” issue and exchanges evolve to solve this problem. Some transparency occurs before a trade is executed: e.g. posting of bids or offers; desired quantities may also be revealed with these quotes. After a trade has occurred, various bits of information also may be revealed, for example, transaction price and, lot size. On the other hand, a rare bit of information in markets is the identity of a trader. There has been great success of electronic trading venues due to anonymity, thus placing all traders on a level playing field, protecting trading strategies and thus encouraging trading.

There is a link between liquidity and transparency. Liquidity is the market characteristic which directly impacts individual traders, whereas transparency has a broader relationship with trading. Some markets are transparent and illiquid (real estate) and others are liquid with little transparency. In some cases, full transparency may reduce liquidity by reducing participation. Some transparency will have the effect of revealing particular trading strategies, which would otherwise be valuable proprietary information. Revealing this information will discourage participation and harm liquidity. A benefit of anonymous trading provides a marketplace where traders need not fear revelation of their particular strategies when executing their trades. Traders large and small come as anonymous equals, competing solely on the basis of price and time priority. Changes to required transparency will impact market liquidity and thus efficiency. In an extreme adverse case, some traders may be driven away from exchanges to bilateral phone markets with extremely low transparency, or disappear into overseas markets.

One aspect of an embodiment hereof is support for multilateral negotiations, that is, multiple buyers and/or multiple sellers seeking to compete for the same transactions(s). While such markets exist in fungible goods, such as stock shares, these types of forums are rarer in non-commodity goods, where the buyer and seller must exploit particular knowledge of the specific goods to be transacted and use expertise. This is facilitated by the availability of detailed information in a database of the specific goods, and rich market transaction information which provides at least historical trends and relationships to assist in determining the affect of particular items of information on value. This information is preferably generally available, so that a generic market model may be provided, but also each participant has an opportunity to mine that data based on its own private information, expertise, and goals.

In derivatives markets, for every buyer, there is a seller. There is no “net” open interest; nor excess of buyers or sellers. An open interest is a measure of volume of contracts open at any time. This is the quantity to be delivered and similarly, the quantity to be received. The level of trading and level of open interest in a commodity market naturally increase when volatility increases. Many firms find it beneficial to hedge at least some of their future trading needs (e.g., net sales or consumption), particularly when they perceive increased volatility. An increase in price volatility and threatened disruptions naturally increase the demand for hedging. An increase in volatility also draws in increased speculation. Speculators seek profits at the time of increased volatility and this serves to moderate price movements. An open interest market mitigates volatility, due to increased depth or liquidity from the open positions. Thus, for example, a gemstone derivatives market may be of benefit to both traders of goods seeking delivery and receipt, as well as opportunistic financial investors who generally do not seek delivery and receipt of goods. Likewise, the availability of efficient, liquid, and transparent markets permits speculators to hold long or short positions.

Many markets typically benefit from speculation. “Uninformed” or “noise” trading reflects a lack of information about the fundamentals of a commodity. In commodities markets, speculative traders include hedge funds, investment banks, and other managed money, as well as a small retail trader component. If a speculator buys futures based on some technical analysis (simply looking at price patterns) without knowing anything about current supplies or demand, such trading is clearly not based on fundamental information, simply perceived inefficiencies related to prices themselves. In an efficient market, the theoretical gains from purely historical pricing analysis of the market is limited, especially where the arbitrage opportunities are publicly known. Speculators help solve the no-trade problem where informed buyers and sellers might otherwise hesitate to trade with each other. Speculators add liquidity; with more noise traders buying and selling, there is more of a chance that fundamental traders demanding immediacy will have counterparties willing to trade at the same time and place. This factor may prove significant in establishing markets for relatively rare gemstones, for example 5 carat and larger diamonds. In cases where there is a lack of speculation, there are potentially large liquidity shocks with prices pushed far from fundamental values. Arbitrage trading keeps prices balanced geographically. Arbitrage also works across time; anticipation of high future demand will lead speculators to purchase futures and forwards thus raising forward prices and encouraging storage, conservation and increased production to meet that anticipated demand and thus facilitate efficient allocation across time. Commodities for which there is no trading on organized exchanges have extremely low transparency.

Therefore, by providing an exchange system with pricing transparency, and liquidity, informed interests seeking to trade based on market fundamentals are benefited, and purely financial interests and speculators are also provided with opportunities to benefit.

While the database as discussed herein therefore potentially provides new opportunities for creating liquid exchanges for new classes of goods, as well as futures and forwards exchanges derivative from the markets themselves, the present invention also provides other opportunities.

Derivative Market for Gemstones

As discussed above, once a liquid and efficient market is established and pricing is transparent, pricing volatility may be buffered by derivative markets.

Derivatives are powerful financial instruments that have been widely used by corporations, financial institutions, agricultural industrialists, and even national governments and agencies, typically to better manage asset and liability portfolios, hedge financial and commodities market risk, and minimize costs of capital funding. Additionally, speculators have long been a fixture in the derivatives market primarily to utilize derivatives to hedge and undertake economic exposure where there are inherent risks, such as risks of fluctuations in interest rates, foreign exchange rates, convertibility into other securities or outstanding purchase offers for cash or exchange offers for cash or securities. Similarly, investors may also take positions in commodities markets and derivatives of such markets to gain exposure to corresponding risks.

Despite the presence of derivatives markets in other mining industries such as gold and copper, controlled supply and prices of diamonds and other gemstones may have prevented the emergence of a derivatives market in the diamond industry. Historically, diamond mining companies (i.e., producers] have controlled supply of rough stones to the diamond industry. However, this control has been reduced by the emergence of competing sources, and a change in business model by the mining interests. The entrance of new mining companies has weakened the ability of any one party to limit supply. This has made the diamond trade market sensitive. With the presence of market volatility, the entire diamond industry is exposed to price fluctuation risk.

One way to hedge the risk of market price fluctuations for commodity goods is through a futures market and corresponding derivatives market. Thus, for example, by short selling a marketable commodity, it is possible for industrialists with inventory to offload the risk of price fluctuations onto an external investor. By transferring that risk, the remaining business models have lower risk, which may support more conservative financing at correspondingly lower rates. On the other hand, an investor may rationally seek to assume this type of risk, both for general diversification of portfolio risk, and because of a specific desire or need. In other cases, an investor may simply seek the higher rates of return implied by the volatility of the commodity price.

This type of derivative market has not generally been possible in the gemstone industry, and particularly the diamond industry, because gemstones are typically not strictly commodities, in that each stone is unique, and there are a large number of different characteristics that affect their value, some in subjective ways. Likewise, this value is ultimately driven by consumer demand, and therefore various segments of the industry may be subject to seasonal, economic and regional perturbations, which may prove more difficult than corresponding perturbations in other commodities markets to predict and compensate for, since in the cut diamond/diamond jewelry industry, the end use of the stones is a discretionary purchase.

Derivatives can be traded over-the-counter (OTC), as is done for forwards contracts, or on exchanges as is the case for futures and options, and the trade occurs between two or more derivative counterparties. Forwards and futures are designed to reduce risks related to the uncertainty of fluctuating future market prices for both buyers and sellers of underlying assets. A forward contract provides that at a certain time in the future, one party will deliver a pre-agreed quantity of some underlying asset (or its cash equivalent in the case of non-tradable underlyings, assuming that such a cash price is calculable based on a predetermined formula) and the other party will pay a pre-agreed amount of money, i.e. the “forward price”. A future is simply a standardized forward which is traded on exchanges with respect to a commodity asset, that is, a class of assets meeting a certain description, the delivery of which meeting that description is sufficient to meet the requirements of the contract. A future requires a liquid market to establish a cash value on at least the delivery date.

Indeed, all futures listed on U.S. exchanges are marked to market at the end of every working day, and the buyer and seller must post an initial margin that acts as a security deposit to ensure availability of funds to mark to market. Contracts are settled in cash and only in special cases, the seller has to physically deliver the asset (mostly in the commodities market).

Options are the most flexible of all derivatives and may be used to hedge risks by allowing parties to agree on a price for a purchase or sale of another instrument that will take place at a later time. One type of an option, a call option, gives the purchaser of the option the right, but not the obligation, to buy a particular asset either at (European option), or at or before (American option) a specified later time at a guaranteed price, whereupon the guaranteed price is sometimes referred to as a strike or exercise price. Alternatively, a put option gives the purchaser of the option the right, but not the obligation, to sell a particular asset at a later time at the strike price.

Options pricing theory has been described by Black and Scholes, and later economics researchers. According to the Black-Scholes model, the future value of an option is described with respect to the pricing volatility of the underlying asset, with higher volatility leading to a higher present value. Thus, in a volatile market, a holder of commodity inventory may sell an option to obtain present revenues for possible future sales, trading the possibility of future gain in price for the present option payment. Efficient trading in the options therefore requires rich transaction pricing to allow a trader to estimate the volatility.

Thus, to hedge a future price risk, for example, a party would sell puts on its inventory, and therefore gain a present revenue, but risk being forced to sell assets at a fixed price in the future under circumstances where the market price is in excess of the required payment. A market participant, indeed, could increase it risk by selling short its future inventory, risking having to cover if the options are exercised. To a party that trades in the asset, this would require covering the optioned inventory in the open market, which could result in market perturbations for lightly traded or illiquid assets.

In order for the derivatives market to operate successfully, the market must be liquid. However, unlike gold, copper, and other commodities, diamonds are not fungible. In other words, the value of one carat of diamond is not necessary of the same value as another. Diamond characteristics which determine value encompass cut and proportions, color, clarity, carat weight, origin, treatments, certifications and gemological reports, and possibly other factors, thus leading to an enormous variety of possible qualities (degrees of freedom), making the prediction of pricing of each unique diamond a challenge. Some attempts at publishing or establishing a market price for diamonds include the index pricing list at PolishedPrices.com, and the interactive online diamond exchange on RapNet set up by Martin Rapaport. However, these lists are based on “asking” or “best” prices instead of using a market price, and require transaction fees which tend to be a significant percentage of the actual value of the diamond. Likewise, each diamond transaction prudently requires a gemological analysis, to ensure that the goods meet the description. Thus, these existing systems do not fully meet the need for a diamond exchange that allows market prices to exist in addition to generating very low transactional costs of exchange.

In a derivatives market where the physical delivery of a commodity is a likelihood, there exists a need for an efficient and secure verification process that ensures that all of the deliverables are exactly as specified on the contract, or a mutually agreeable mechanism for assessing compliance and adjusting the pricing in the event of deviance. In some commodities, a statistical sampling of the goods is sufficient to represent the entirety, while in a diamond market, each stone must be individually analyzed and verified. Indeed, assuming that the diamond inventory which is the subject of contracts (with a right of substitution) represents the working inventory of companies in the trade, there is a significant possibility that the portfolio of stones will not be identical between the time of contract entry and closure. Therefore, the right of substitution is important to gaining market liquidity and involving the trade. Indeed, since a significant purpose of the transaction is hedging of financial risks, the implementation of financial offsets to represent differences in value between the contracted lot and the delivered lot is important. However, as stated above, the market value for a particular diamond is currently difficult to estimate with certainty, resulting in a possibility for arbitrage and resulting economic inefficiency.

Therefore, a gemstone derivative market system must address for purposes of both investment and use the interchangeability and pricing of gemstones, and provide a system which serves both speculators in the gemstone markets and the business of the cut diamond and diamond jewelry trade.

Typically, in order to facilitate efficient trading of stones, each stone will be graded once, and the certificate describing the grading will be associated with the stone by way of a micro marking of the stone, such as a laser etched serial number. This may avoid the need to sequester the stones in a bonded vault to isolate gemstones to prevent substitution, which would separate the investment market from the trade, and likely result in pricing disparity and artifacts, and ultimately arbitrage opportunities. Cryptographic and other methods have been previously proposed for authenticating a particular stone and associating it with an appropriate certificate. Currently a system and method exists (see U.S. Pat. No. 7,010,938, expressly incorporated herein by reference) for marking stones, e.g., using a laser, and which can image the stone and the marking thereon, capturing non-deterministic characteristics which are difficult or impossible to counterfeit, and storing that information in a database. The marking may be formed by an energy beam, which may be a light source, a CW laser, pulse laser, ion milling device, electron beam, or the like, which is used to mark (or alter a portion of) a gemstone with a microscopic pattern. The energy beam may directly produce an effect on the gemstone, or produce an effect in a coating on the stone, which is subsequently used as a basis to mark the stone. Alternately, the energy beam may result in a selective deposit on the stone. With respect to gemstone coatings, the energy beam may result in a maintenance or removal of the coating, depending on the nature of the beam and the nature of the coating material.

The buying/selling of rough diamonds by the producer to the cutter is currently an inefficient process. The selling of rough diamonds by the producer to the cutter is done in baskets of diamonds or “boxes”. The cutter generally is not provided the option to choose certain specifications of diamonds one by one; rather, an entire box of diamonds (or a high percentage thereof) must be bought, and this poses a problem as the cutter's customer demand may not match with the types of diamonds in the producer's box. For example, in one year a particular producer may provide six thousand rough diamonds which economically lend themselves to being cut into fancy shape stones and four thousand rough diamonds that economically lend themselves to being cut into round stones of a certain type in one box whereas the cutter would like to have five thousand round diamonds and five thousand fancy shape diamonds as calculated from his customer's demand. In general, the demand from the customer base of the cutter does not match the optimal supply (box contents) of rough diamonds from the mines, and therefore some box contents are in higher demand than others, leading to a complex pricing relationship between components. While the presence of a liquid diamond market may alleviate this somewhat, the trade of rough stones is more consolidated than cut stones, and a transparent exchange in these goods may result in a release of significant proprietary information; thus, in contrast to the cut stones, it is possible but less likely that the rough stone trade is suitable for an open exchange market. On the other hand, by increasing liquidity for the cut and polished inventory, this will inherently increase liquidity for the upstream suppliers, since the flow of inventory through the supply chain is more efficient.

Financial derivatives dependent on the gemstone market to hedge risk therefore provide those in the gemstone trade the ability to lock in prices for future stones, thus minimizing risk against price volatility. Further, the automated market system for diamonds and gemstones increases their liquidity to permit efficient transactions between businesses and financiers.

The present invention provides a system and method for providing a market exchange, and a related financial derivative exchange, for diamonds and other gemstones. It is typically preferred that commodities exchanges be tightly linked to the markets for the underlying commodities, without themselves distorting the pricing. In order to provide such linkage, the transactional expenses to establish the quality and value of the goods under contract should be readily ascertainable. Preferably, a certificate for a particular good or lot is easily matched with the good or lot, and reasonably transferable to avoid the need for re-appraisal during each transaction. This may be accomplished through micro marking of the goods, as discussed above.

Gemstones therefore have not been previously readily available as a basis for trading financial derivatives because each stone is unique, and the value depends on type, weight, cut, color, clarity, treatments, origin, etc. Therefore, creating a fungible portfolio of stones is difficult, ascertaining the rules of substitution of goods is not generally agreed upon between all potential buyers and seller, and imposition of strict and arbitrary rules may lead to undue arbitrage opportunities and resulting inefficiencies. Further, stones which are locked in a portfolio are typically unavailable to the markets at large, leading to a possible divergence over the course of a contract between derivatives pricing and market pricing.

An embodiment of the present invention provides a system for individually tracking stones, using a unique code (i.e., a brand code) on each stone, linked to a database entry, which, for example, may include or reference an impartial (or otherwise mutually acceptable between buyer and seller) appraisal or description of the stone. The brand code may be made difficult or nearly impossible to reproduce, thus leading to a certifiable association between the brand code on the stone and a database entry or certificate for that stone. By providing a large, and ever growing inventory of certified stones, the potential inventory base for the exchange of financial derivatives is assured, and the linkage between the spot market exchange and derivatives market pricing is facilitated. Due to the availability of certificates/grading reports (physical or electronic) and their accompanying description of the characteristics of a stone, portfolios established based on physical inventory may be assembled ad hoc, and if the physical inventory changes before delivery date, the option may exist to replace the inventory with like kind (“cover”), or to use market pricing to establish an offset value.

Typically, different grading laboratories have different grading criteria or parameters, leading to a degree of discretion in comparing reports from various labs or gemologists. Accordingly, another embodiment of the invention provides a translation or equivalency determination scheme between certificates from different labs. For example, a gemstone color determination of the same stones by different labs may be disparate. However, often the labs are consistent in their determinations, or the degree of variance measurable. Therefore, it is possible to standardize comparisons, even if the laboratories (or other grading sources) themselves are not jointly standardized. One way to normalize this difference is to provide a calculated subjective quality factor(s) using data contained in or derived from a database, e.g., a number from 1 to 10, which compensates for differences in various aspects of grading reports and schemes. This factor, for example, may represent an actual or predicted offset from a price determined by a pricing model based on the basic information in the certificate alone, and thus would typically persist as an offset factor even if the market price changes.

One way to minimize the arbitrage opportunity, and thus create uniform expectation in pricing between buyer and seller, is to closely match the deliverable goods to the contracted goods, and providing access to a liquid market for selling the entire range of goods. By providing reliable classification and certification of goods, the administrative costs are vastly reduced, decreasing the required change in circumstances to rationally justify a trade. By making such threshold low, liquidity is increased, and therefore the incidents of pricing artifacts and perturbations reduced.

The certification/grading process not only facilitates the commodities market for the stones, but also the entire chain of commerce from the point(s) of certification/grading to the end customer. For example, a cut and polished stone may be analyzed, and certified/graded, with an authenticatable laser inscription or micro mark placed on a surface. Preferably, the branding code requires a third party branding coordinator to implement, and thus each branding code is traceable to the branding coordinator, much in the way that public key cryptographic infrastructures include certification authorities. If, for example, the branding code includes an encrypted message of cryptographic hash derived from the branding coordinator, this will reduce the incidence of fraudulent markings. Preferably, the branding codes are maintained in a database which permits users to remotely authenticate a stone based on its respective markings and ascertainable characteristics.

Assuming that both the derivatives market and spot market are liquid, a pricing index that shows fluctuations in value of gemstones may be employed, valid for both venues. This will, in turn, facilitate the ability of stake holders to speculate or hedge against their physical diamond inventory; plus, future expectations of supply and demand can lead to corrections in current price. By providing free opportunity for funds to move into and out of the market, pricing fluctuations will be buffered.

A purchaser may determine whether his deliverables accurately correspond to the contract, preferably by use of an online searchable database that contains serial numbers or unique codes (brand codes) of all or many certified/graded gemstones that have been micro-marked with an inscription that provides a unique identifying serial number. Each entry in the database will provide certain of the details of each stone, such as grading certificate information, authentication information, etc. This allows the owner to input each stone's serial number into a computer (manually or automatically) and view important details. This process can be automated for a large set of assets, thus enabling verification of all the deliverables with minimum handling. To facilitate automated reading through a video microscope or photomicrograph, the information may be presented in a linear bar and/or a two dimensional data matrix code. The reader may be, for example, a megapixel or higher imager with a lens providing a field of view of 2 mm at the focal plane (e.g., about 2 microns per pixel), which can connect to an automated reader through, for example, a USB or Firewire port (IEEE-1394).

According to another embodiment of the invention, the price fluctuation risk is assumed by investors, while the consumption of the asset is decoupled from this risk. Therefore, a diamond cutter can enter into a repurchase agreement for the diamonds with an investor, who will then alleviate the diamond cutter of the carrying cost for the inventory and/or some or all of the pricing risk. The investor, on the other hand, assumes the fluctuation risk. The contract provides a right of substitution, allowing each party to carry on his business and conduct ancillary trades, such as to hedge risks. Upon the delivery date, either the original assets are returned, or substitute assets having highly similar characteristics are delivered, or an offset fee imposed. In the later case, a mutually agreed basis for the offset is provided, for example the spot market price for the asset.

The present invention thus does not require full fungibility of traded assets, instead relying on grading/certification and authentication, accurate pricing models based on broad based market transactions, and often, purchase agreements which are at market price at the time of delivery. In some cases, the agreement will be a repurchase agreement, (i.e., a present sale at market price, coupled with a future obligation to re-acquire the assets or their equivalent from the buyer at the then current market price.)

This idea can also be used to create a derivatives and futures market in real estate. Two parties could form an option contract to purchase a given property at a given time in the future. If the given property is not on the market at the given future time, then the property could be replaced with another property matching all the specifications of the previous one. For example, the parties could agree on an option contract that gives the buyer an opportunity to purchase a rental property having two bedroom, two bathroom condo on the fifth floor or higher on Manhattan's Upper East Side, generating certain cash flows and tax consequences, for a certain price, to be exercised by a given date in the future. Such a market is likely of more use to investors seeking exposure to risk than to “retail” buyers, to whom location per se is more important than value.

On the other hand, in the case of a diamond market, if the contracts cover uncut stones, the market can be effectively isolated from retail channels of trade. On the other hand, if the stones are cut gemstones, these more explicitly implicate the retail market. Thus, as retail demand increases for a particular category, the value of that category will change with respect to other categories in which demand is less. The retail demand may be seasonal, and often subject to economic fluctuations affecting disposable income.

On the other hand, a system and method which embraces the retail sector may be advantageous. This is because it provides a user of a durable product who may be willing to undertake the carrying costs of the “commodity” (e.g., cut gemstone), while avoiding the equity risks. Thus, similarly to a lease of a car or real estate, a gemstone may be leased to a consumer who pays a fixed fee related to a finance cost to an owner. (In some cases, the fees may be variable and/or derivative on some secondary factor). The owner, on the other hand, undertakes the equity risks, without being subject to unsubsidized carrying costs. Indeed, there may be an additional tax advantage, since leased property may generally be depreciated, for example, by the leaser. Likewise, this linkage with retail may increase volatility.

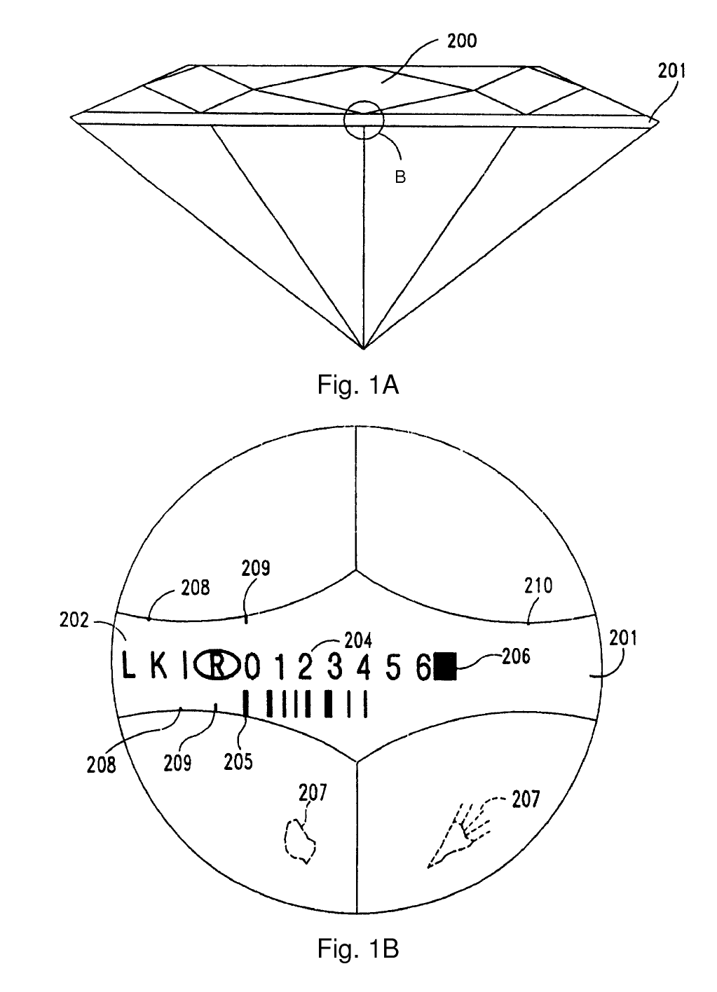

A diamond 200, as shown in FIG. 1A, and shown in greater detail in FIG. 1B is provided with a number of identification and security features. The diamond 200, for example, is a color D stone weighing 1.01 Carats, grade VS2 with two identified flaws 207. The diamond 200 has a set of markings inscribed on the girdle 201. The markings include an “LKI” logo 202, formed as characters, a trademark registration symbol 203, a serial number in Arabic numerals 204, a one dimensional bar code 205, a two dimensional code 206, a set of visible dimensional references 209, and single ablation spots 208, 210 having defined locations. For most purposes, the logo identifies the series of markings, while the serial number is used to identify the diamond 200. In order to encode further information, a visible bar code 205 allows, for example, digital (discretely encoded) information to be encoded and retrieved from the diamond 200. The bar code and/or two dimensional codes generally require a machine for reading, and medium and high density data encoding. The visible dimensional references 209 allow use of a reticule to measure distances, providing additional characteristics of the diamond 200 which may be used to uniquely define the diamond 200. The single ablation spots 208, 210 are less visible, and may thus require a key for searching; that is, it may be difficult to find and encode the locations from the stone itself, but easier to verify the stone based on information describing the location of the single spots. In other words, authentication of these spots may require transmission of their location, with confirmation by inspection of the diamond 200. The marking 210, for example, has a defined physical relation to one or both flaws 207, making copying very difficult, since this would require counterfeiting the flaws, inclusions or other visible indicia, or finding another stone with those same flaws, inclusions or indicia.

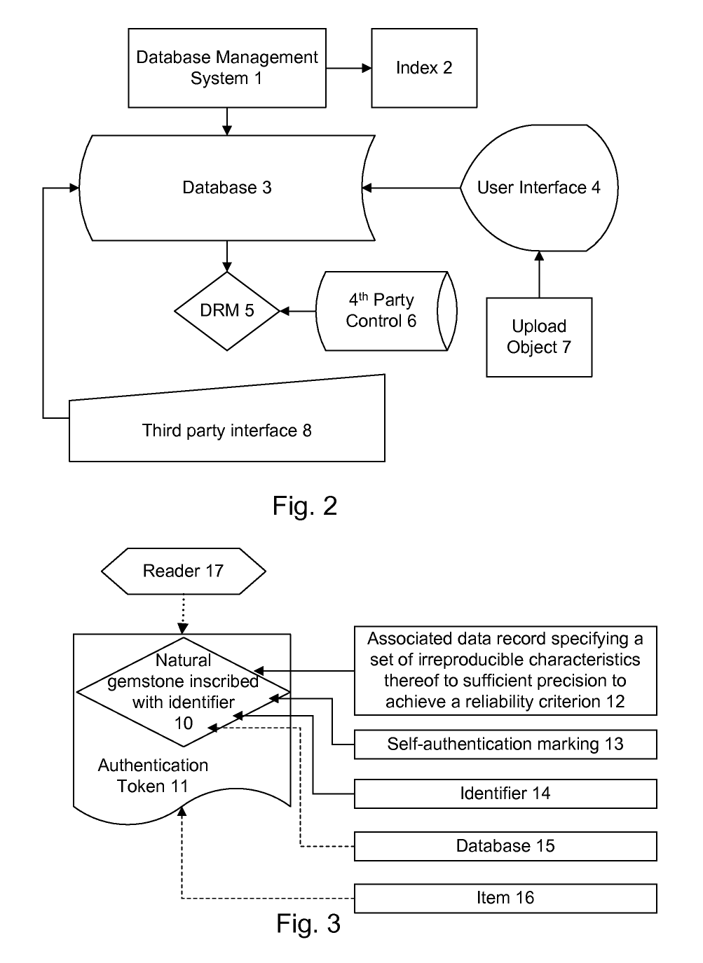

FIG. 2 shows a schematic representation of a an online database system, having a database 3, adapted to store arbitrary digital objects, each record within the database being retrievable by a database management system 1 by reference to at least one index 2. A user interface 4, for receiving an identifier from a user, presenting to the user a representation of at least one digital object, the index of the digital object being logically associated with the identifier, and receiving from the user at least one digital object 7 for storage in the database 3. An index is assigned which is logically associated with the identifier. A third party interface 8, permits a third party to add data to the database 3, which is logically associated with the identifier in dependence on a content of the data, and without requiring knowledge by the third party of the identifier. At least one digital object stored in the database 3 may be subject to a digital rights management 5 restriction which requires compensation to a fourth party 6 for use of the digital object, wherein the database management system 1 accounts for use of the digital object and compensates the fourth party. The third party and the fourth party may be the same or different.

FIG. 3 shows a schematic representation of an authentication token 11. The authentication token 11 includes a natural gemstone 10, having an associated data record 12 to specify a set of irreproducible characteristics thereof to sufficient precision to achieve a reliability criterion, said gemstone being inscribed with at least one of an identifier 14 for lookup in a database 15 and a self-authentication marking 13, the database 15 or self-authentication marking 14 storing sufficient information to permit reliable authentication of the gemstone 10, the authentication token 11 being logically associated with an item to be authenticated, and wherein a reliable authentication of the gemstone 11 serves to reliable authenticate the item 16. The irreproducible characteristics may include, for example, a set of markings made on the gemstone 11, a set of natural imperfections of the gemstone 11, or a cut configuration of the gemstone 11. An automated reader 17 may be provided for reading the data record and the set of irreproducible characteristics, and determining an authenticity of the gemstone 11.

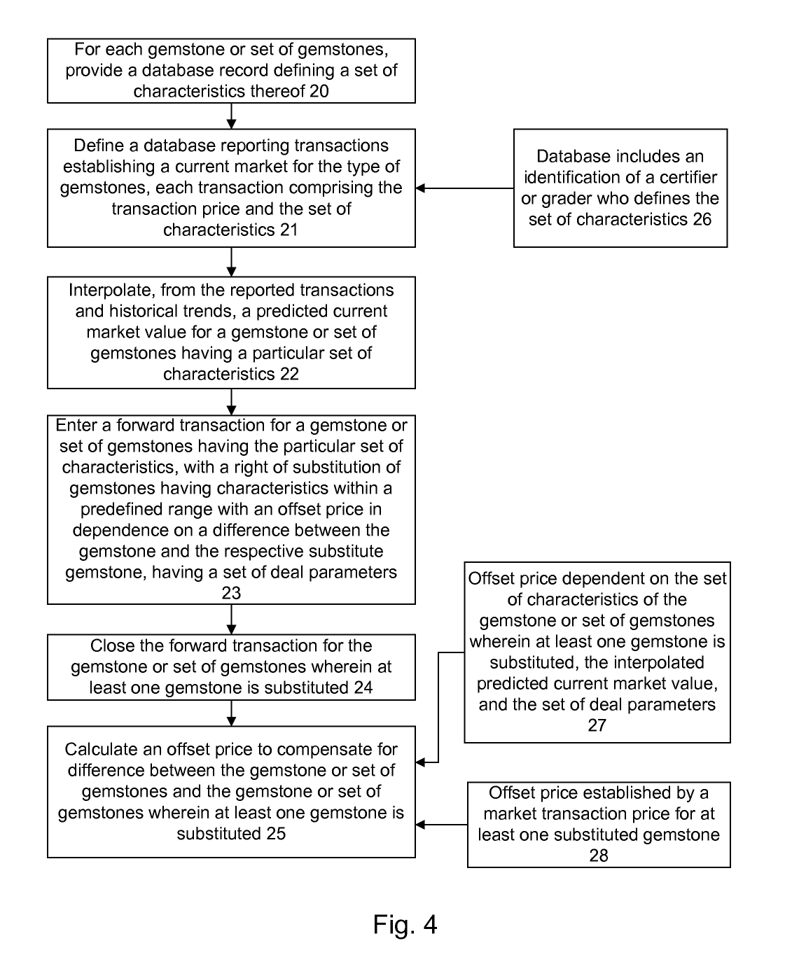

A method of establishing a forward market for a type of gemstones is shown in the flowchart of FIG. 4. For each gemstone or set of gemstones, a database record is provided defining a set of characteristics thereof 20. A database is defied reporting transactions establishing a current market for the type of gemstones, each transaction comprising the transaction price and the set of characteristics 21. From the reported transactions and historical trends, a predicted current market value for a gemstone or set of gemstones having a particular set of characteristics is interpolated or predicted or established or estimated 22. A forward transaction is then entered into for a gemstone or set of gemstones having the particular set of characteristics 23, with a right of substitution of gemstones having characteristics within a predefined range with an offset price in dependence on a difference between the gemstone and the respective substitute gemstone, having a set of deal parameters. The forward transaction for the gemstone or set of gemstones is then closed 24, in a transaction which permits at least one gemstone to be substituted. In the case of a substitution, an offset price to compensate for difference between the substituted gemstone or set of gemstones and the original gemstone or set of gemstones is calculated 25. The database record may include an identification of a certifier or grader who defines the set of characteristics 26. This is useful, for example, where different certifiers have different standards or meanings for gradings, or where some certifiers or graders are deemed more reliable or consistent or accurate or precise than others. The offset price may be dependent on the set of characteristics of the substituted gemstone or set of gemstones, the interpolated predicted current market value, and the set of deal parameters 27. The offset price may also be established by a market transaction price for at least one substituted gemstone 28.

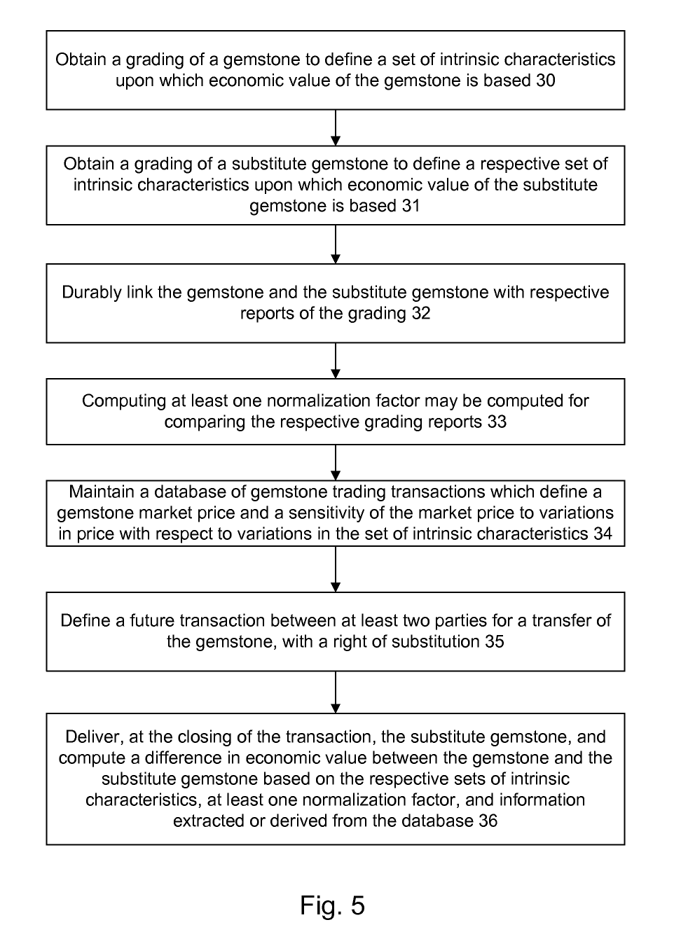

FIG. 5 shows a flowchart for a method for trading a natural gemstone. A grading of a gemstone, to define a set of intrinsic characteristics upon which economic value of the gemstone is based, is obtained 30. A grading of a substitute gemstone, to define a respective set of intrinsic characteristics upon which economic value of the substitute gemstone is based is also obtained 31. The gemstone and the substitute gemstone are each durably linked with respective reports of the grading 32. At least one normalization factor may be computed for comparing the respective grading reports 33. A database of gemstone trading transactions is maintained 34 which define a gemstone market price and a sensitivity of the market price to variations in price with respect to variations in the set of intrinsic characteristics. A future transaction between at least two parties, for a transfer of the gemstone, with a right of substitution, is defined 35. At the closing of the transaction, the substitute gemstone is delivered 36, and a difference in economic value between the gemstone and the substitute gemstone is computed based on the respective sets of intrinsic characteristics, at least one normalization factor, and information extracted or derived from the database.

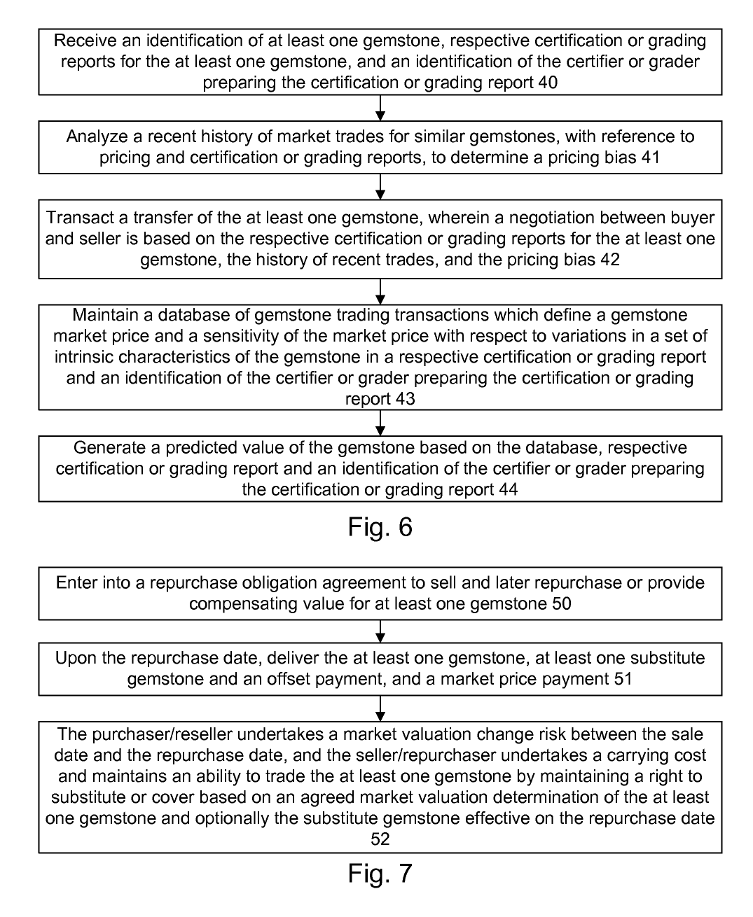

An automated method for trading method for gemstones is shown in the flowchart of FIG. 6. An identification of at least one gemstone, respective certification or grading reports for the at least one gemstone, and an identification of the certifier or grader preparing the certification or grading report is received 40. A recent history of market trades for similar gemstones is analyzed, with reference to pricing and certification or grading reports, to determine a pricing bias 41. A transfer of the at least one gemstone is transacted 42, wherein a negotiation between buyer and seller is based on the respective certification or grading reports for the at least one gemstone, the history of recent trades, and the pricing bias. A database of gemstone trading transactions, which define a gemstone market price and a sensitivity of the market price with respect to variations in a set of intrinsic characteristics of the gemstone in a respective certification or grading report may be maintained 43, with and an identification of the certifier or grader preparing the certification or grading report. A predicted value of the gemstone may be predicted 44 based on the database, respective certification or grading report and an identification of the certifier or grader preparing the certification or grading report.

FIG. 7 shows a flowchart of a method of transferring a pricing volatility risk from a gemstone. A repurchase obligation agreement is entered into, to sell and later repurchase or provide compensating value for at least one gemstone 50. On the repurchase date, the at least one gemstone or at least one substitute gemstone and an offset payment are delivered, the offset payment being determined based on a market price for the at least one gemstone and at least one substitute gemstone. The purchaser/reseller undertakes a market valuation change risk between the sale date and the repurchase date, and the seller/repurchaser undertakes a carrying cost and maintains an ability to trade the at least one gemstone by maintaining a right to substitute or cover based on an agreed market valuation determination of the at least one gemstone and optionally the substitute gemstone effective on the repurchase date 52. The repurchase may occur, for example, at a predetermined time, at a time selected by the purchaser, or at a time selected by the seller. The seller may contract with a third party to cover on his behalf.

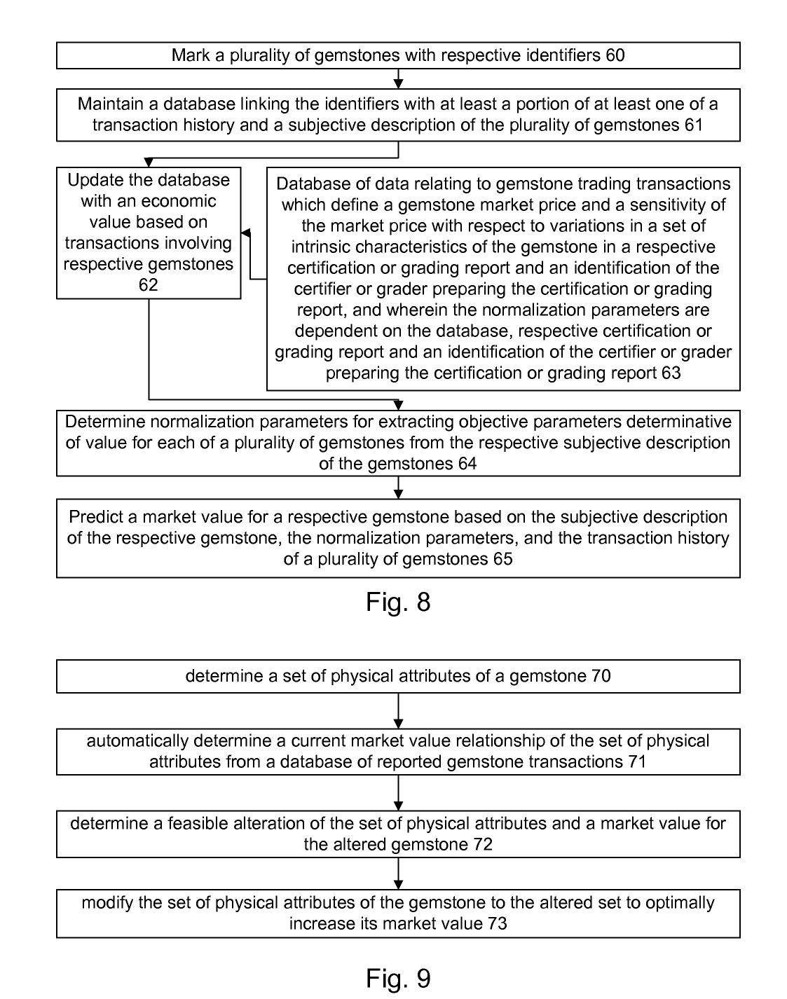

FIG. 8 shows a flowchart of an online database method. A plurality of gemstones are marked with respective identifiers 60. A database is maintained linking the identifiers with at least a portion of at least one of a transaction history and a subjective description of the plurality of gemstones 61. The database is updated with an economic value based on transactions involving respective gemstones 62. Normalization parameters for extracting objective parameters determinative of value for each of a plurality of gemstones from the respective subjective description of the gemstones are determined 64. A market value for a respective gemstone is predicted based on the subjective description of the respective gemstone, the normalization parameters, and the transaction history of a plurality of gemstones 65. The database may include data relating to gemstone trading transactions which define a gemstone market price and a sensitivity of the market price with respect to variations in a set of intrinsic characteristics of the gemstone in a respective certification or grading report and an identification of the certifier or grader preparing the certification or grading report, and wherein the normalization parameters are dependent on the database, respective certification or grading report and an identification of the certifier or grader preparing the certification or grading report 63.

FIG. 9 shows a flowchart of a further method. A set of physical attributes of a gemstone are determined 70. A current market value relationship of the set of physical attributes from a database of reported gemstone transactions is automatically determined 71, for example by a computer system having a processor, memory, computer readable medium for storing instructions controlling the processor to perform the method, various inputs and outputs, and a power supply. Likewise, such a computer system is applicable for implementing other methods disclosed herein. A feasible alteration of the set of physical attributes and a market value for the altered gemstone is determined 72. The set of physical attributes of the gemstone may be modified to the altered set to optimally increase its market value 73.

There has thus been shown and described novel systems and method and related databases, which fulfill all the objects and advantages sought therefor. Many changes, modifications, variations, combinations, subcombinations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. An authentication token, comprising a natural gemstone, having an associated data record to specify a set of irreproducible characteristics thereof to sufficient precision to achieve a reliability criterion, said gemstone being inscribed with at least one of an identifier for lookup in a database and a self-authentication marking, the database or self-authentication marking storing sufficient information to permit reliable authentication of the gemstone, said authentication token being logically associated with an item to be authenticated, and wherein a reliable authentication of said gemstone serves to reliable authenticate the item.

2. The authentication token according to claim 1, wherein the irreproducible characteristics comprise a set of markings made on the gemstone.

3. The authentication token according to claim 1, wherein the irreproducible characteristics comprise a set of natural imperfections of the gemstone.

4. The authentication token according to claim 1, wherein the irreproducible characteristics comprise a cut configuration of the gemstone.

5. The authentication token according to claim 1, in combination with an automated reader for reading the data record and the set of irreproducible characteristics, and determining an authenticity of the gemstone.

6. A method of transferring a pricing volatility risk from a gemstone, comprising:
entering into a repurchase obligation agreement to sell and later repurchase or provide compensating value for at least one gemstone; and
upon the repurchase date, delivering the at least one gemstone, at least one substitute gemstone and an offset payment, and a market price payment;
wherein the purchaser/reseller undertakes a market valuation change risk between the sale date and the repurchase date, and the seller/repurchaser undertakes a carrying cost and maintains an ability to trade the at least one gemstone by maintaining a right to substitute or cover based on an agreed market valuation determination of the at least one gemstone and optionally the substitute gemstone effective on the repurchase date.

7. The method according to claim 6, wherein the repurchase occurs at a predetermined time.

8. The method according to claim 6, wherein the repurchase occurs at a time selected by the purchaser.

9. The method according to claim 6, wherein the repurchase occurs at a time selected by the seller.

10. The method according to claim 6, wherein a seller contracts with a third party to cover on his behalf.

11. A method, comprising the steps of:
determining a set of physical attributes of a gemstone;
automatically determining a current market value relationship of the set of physical attributes from a database of reported gemstone transactions;
determining a feasible alteration of the set of physical attributes and a market value for the altered gemstone; and
modifying the set of physical attributes of the gemstone to the altered set to optimally increase its market value.

12. An online database system, comprising:
a database, adapted to store arbitrary digital objects, each record being retrievable by a database management system by at least one index;
a user interface, for receiving an identifier from a user, presenting to the user a representation of at least one digital object, the index of the digital object being logically associated with the identifier, and receiving from the user at least one digital object for storage in the database wherein an index is assigned which is logically associated with the identifier; and
a third party interface, permitting a third party to add data to the database, which is logically associated with the identifier in dependence on a content of the data, and without requiring knowledge by the third party of the identifier.

13. The online database system according to claim 12, wherein at least one digital object stored in the database is subject to a digital rights management restriction which requires compensation to a fourth party for use of the digital object, wherein the database management system accounts for use of the digital object and compensates the fourth party, and wherein the third party and the fourth party may be the same or different.
